(19) United States
(12) Patent Application Publication
(10) Pub. No.: US 2025/0184912 A1
(43) Pub. Date: Jun. 5, 2025

(54) METHOD AND DEVICE IN A NODE FOR POWER CONTROL IN WIRELESS COMMUNICATION

(71) Applicants: Qi JIANG, Shanghai (CN); Ping WANG, Shanghai (CN); Xiaobo ZHANG, Shanghai (CN)

(72) Inventors: Qi JIANG, Shanghai (CN); Ping WANG, Shanghai (CN); Xiaobo ZHANG, Shanghai (CN)

(73) Assignee: SHANGHAI LANGYAO COMMUNICATION TECHNOLOGY COMPANY LIMITED, Shanghai (CN)

(21) Appl. No.: 18/959,690

(22) Filed: Nov. 26, 2024

(30) Foreign Application Priority Data
Dec. 3, 2023 (CN) 202311645973.6

(51) Int. Cl. H04W 52/24; H04B 7/04; H04L 5/00

(52) U.S. Cl. CPC H04W 52/243; H04B 7/04013; H04L 5/0048

(57) ABSTRACT

The present application discloses a method and device in a node for power control in wireless communications. A first node first measures a first reference signal to obtain a first PL (Pathloss); the first reference signal is a synchronization signal indicating a first identifier, or the first reference signal is spatially correlated with a synchronization signal indicating a first identifier; then calculates first power, and adopts the first power to transmit a first radio signal on a first cell; the calculating first power depends on the first PL and a first parameter value; the first parameter value depends on the first identifier associated with the first reference signal. The present application solves the problem of uplink signal power control in the communication system to reduce complexity and improve performance.

### CROSS REFERENCE TO RELATED APPLICATIONS

This application claims the priority benefit of Chinese Patent Application CN202311645973.6, filed on Dec. 3, 2023, the full disclosure of which is incorporated herein by reference.

### BACKGROUND

### Technical Field

The present application relates to transmission methods and devices in wireless communication systems, and in particular to a method and device for power control.

### Related Art

In 2020, the vision of 5.5G industry for 5G evolution was first proposed by the industrial circles. In April 2021, 3rd Generation Partner Project (3GPP) officially identified the name of 5.5G for 5G evolution as 5G-Advanced, which marks the start of the standardization process, and planned to define the 5G-Advanced technical specifications through Rel-18 (Release-18), Rel-19 and Rel-20. By the end of 2021, the Rel-18 has approved 28 projects, and 5.5G technology research and standardization has entered a substantial stage. Future Rel-19 and Rel-20 will further explore new 5G-Advanced services and architectures.

Reconfigurable Intelligent Surface (RIS) is an artificial electromagnetic surface structure with programmable electromagnetic properties, containing a large number of independent low-cost passive sub-wavelength resonant units. Each RIS unit has independent electromagnetic wave modulation capability, and the response of each unit to radio signals, such as phase, amplitude, polarization, etc., can be controlled by changing the parameters and spatial distribution of the RIS units. Through the superposition of wireless response signals of a large number of RIS units, specific beam propagation characteristics are formed on the macro level, thus forming a flexible and controllable formed beam to eliminate the coverage of blind zones, enhance the edge of the coverage and achieve the effect of increasing the rank of multi-stream transmission. RIS technology is characterized by low cost, low energy consumption and programmability, and is easy to deploy, and obtains high beamforming gain with larger antenna size, and thus is regarded as a key technology for research in the 5G-Advanced phase and one of the core visions of 6G.

### SUMMARY

In the RIS scenario, there will be significant differences in the interference environment and signal transmission paths between terminals within and outside the RIS coverage area, and the corresponding PathLoss (PL) may also vary greatly. Therefore, in the RIS scenario, enhancing power control of uplink transmission to handle significant changes in interference environment between RIS coverage area and RIS coverage area is a worthwhile research topic.

To address the above problem, the present application provides a solution. It should be noted that the NR (New Radio) system is used as an example in response to the above problem description, and the present application is equally applicable to, for example, a scenario of a future 6G system, to achieve a technical effect similar to that of the NR system; furthermore, although the original intention of the present application is to target RIS scenarios, it can also be applied to other non-RIS scenarios; furthermore, adopting a unified design scheme for different scenarios (such as other non-RIS scenarios, including but not limited to NCR (Network Control Repeater) capacity enhancement systems, short-range communication systems, NTN (Non-Terrestrial Network), IoT (Internet of Things), URLLC (Ultra Reliable Low Latency Communication) networks, Internet of Vehicles, etc.) can also help reduce hardware complexity and costs. If no conflict is incurred, embodiments in any node in the present application and characteristics of the embodiments are also applicable to any other node, and vice versa. And the embodiments in the present application and the characteristics in the embodiments can be arbitrarily combined if there is no conflict.

Particularly, for interpretations of the terminology, nouns, functions and variants (unless otherwise specified) in the present application, refer to definitions given in TS38 series and TS37 series of 3GPP specifications. Where required, reference may be made to 3GPP TS38.211, TS38.212, TS38.213, TS38.214, TS38.215, TS38.300, TS38.304, TS38.305, TS38.321, TS38.331, TS37.355, TS38.423, to aid in the understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in the 3GPP TS40 series.

In one embodiment, interpretations of the terminology in the present application refer to definitions given in the 3GPP TS39 series.

The present application provides a method in a first node for power control in wireless communications, comprising:
measuring a first reference signal to obtain a first PL; the first reference signal being a synchronization signal indicating a first identifier, or the first reference signal being spatially correlated with a synchronization signal indicating a first identifier; and
calculating first power, adopting the first power to transmit a first radio signal on a first cell;
herein, the calculating first power depends on the first PL and a first parameter value; the first parameter value depends on the first identifier associated with the first reference signal.

In one embodiment, a problem to be solved in the present application comprises: when a reference signal can be associated with multiple identifiers, how to determine the use of power control parameters for the calculation of uplink transmit power.

In one embodiment, a problem to be solved in the present application comprises: power control in RIS scenarios.

In one embodiment, a problem to be solved in the present application comprises: how to determine transmit power of the first radio signal in the RIS scenario.

In one embodiment, a problem to be solved in the present application comprises: when a reference signal can be associated with multiple identifiers, that is, reference signal resources corresponding to a reference signal can be used simultaneously by a direct link of the base station and a reflecting link via RIS, how to determine the use of power control parameters for the calculation of uplink transmit power.

In one embodiment, characteristics of the above method comprise: solving the above problem by associating a reference signal with an associated identifier.

In one embodiment, characteristics of the above method comprise: each identifier in the multiple identifiers indicates a cell.

In one embodiment, characteristics of the above method comprise: the first identifier is used to indicate the first cell.

In one embodiment, characteristics of the above method comprise: the first cell is a secondary cell of the first node, and the first identifier is used to indicate a special cell of the first node.

In one embodiment, characteristics of the above method comprise: establishing a continuity between the identifier and power control parameters, when a first reference signal is associated with different identifiers, i.e., using different power control parameters, to solve the above problem.

In one embodiment, advantages of the above method comprise: the present application supports RIS technology, which has advantages of eliminating coverage blind spots, enhancing edge coverage, and increasing rank through multi-stream transmission.

In one embodiment, advantages of the above method comprise: facilitating the system to adjust the uplink transmission power appropriately, reducing power adjustment delay, and improving system stability.

In one embodiment, advantages of the above method comprise: adjusting transmit power of uplink radio signals more precisely, ensuring reliable transmission of the signal while reducing power consumption of the terminal.

In one embodiment, advantages of the above method comprise: being beneficial to improve the mobile support of the signal and improve the coverage ability of the cell edge.

In one embodiment, advantages of the above method comprise: being conducive to enhancing coverage range and improving the service quality of the system.

According to one aspect of the present application, the above method is characterized in that the first identifier associated with the first reference signal is a first candidate identifier, and the first parameter value is a first candidate parameter value; or, the first identifier associated with the first reference signal is a second candidate identifier, and the first parameter value is a second candidate parameter value.

In one embodiment, characteristics of the above method comprise: the first candidate identifier and the second candidate identifier respectively correspond to scenarios within and outside the coverage area of RIS; or, the first candidate identifier and the second candidate identifier respectively correspond to scenarios where RIS is enabled and RIS is disabled; when the terminal moves under RIS coverage and outside RIS coverage, or in scenarios where RIS itself is a dynamic switch, the above changes do not require a reconfiguration of the first reference signal, thereby avoiding frequent configuration of RRC (Radio Resource Control) signaling and improving system efficiency.

In one embodiment, characteristics of the above method comprise: respectively associating the first candidate identifier and the second candidate identifier with the first candidate parameter value and the second candidate parameter value, which can more accurately adopt appropriate power control parameters to transmit uplink signals.

According to one aspect of the present application, the above method is characterized in that the first power is linearly correlated with a product of the first PL and the first parameter value.

According to one aspect of the present application, the above method is characterized in that the first power is linearly correlated with a product of the first PL and a first coefficient, and the first power is linearly correlated with the first parameter value, and the first parameter value is used to determine expected power.

According to one aspect of the present application, the above method is characterized in comprising:
receiving a first signaling;
herein, the first signaling indicates the first identifier.

In one embodiment, characteristics of the above method comprise: configuring the first identifier associated with the first reference signal through a dynamic signaling or a MAC (Medium Access Control)-layer signaling, which is more timely and efficient.

In one embodiment, characteristics of the above method comprise: avoiding the reconfiguration of the first identifier through an RRC signaling and saving the signaling overhead.

According to one aspect of the present application, the above method is characterized in comprising:
receiving a first broadcast signal;
herein, the first broadcast signal indicates multiple identifiers; the first identifier is one of the multiple identifiers.

In one embodiment, a problem to be solved in the present application comprises: how to determine the multiple identifiers.

In one embodiment, characteristics of the above method comprise: the first broadcast signal explicitly indicates the multiple identifiers, and the explicit indication comprises directly indicating each identifier in multiple identifiers.

In one embodiment, characteristics of the above method comprise: the first broadcast signal implicitly indicates the multiple identifiers, the implicit indication comprises explicitly indicating part of the multiple identifiers and indirectly indicating the another part of identifiers through other pre-configured information.

In one embodiment, characteristics of the above method comprise: the first broadcast signal comprises an MIB.

In one embodiment, characteristics of the above method comprise: the first broadcast signal comprises a PBCH.

In one embodiment, advantages of the above method comprise: when the first broadcast signal explicitly indicates the multiple identifiers, a correlation between multiple identifiers is low, and it is more convenient to meet the parameter configuration rules of different cells, which is conducive to reducing synchronization delay, and avoiding problems such as inability to access the cell.

In one embodiment, advantages of the above method comprise: when the first broadcast signal implicitly indicates the multiple identifiers, the overhead of the first broadcast signal can be reduced on the premise of guaranteeing the cell coverage.

In one embodiment, advantages of the above method comprise: improving the efficiency of broadcast signals.

According to one aspect of the present application, the above method is characterized in comprising:
receiving first physical-layer control information;
herein, the given identifier is any one of the multiple identifiers, and the first physical-layer control information occupies a first physical-layer channel, regardless of which of the multiple identifiers the given identifier is, a second identifier is used to generate at least one of a scrambling sequence of the first physical-layer channel or an RS sequence of a DMRS of the first physical-layer channel.

In one embodiment, a problem to be solved in the present application comprises: how to receive the first physical-layer control information.

In one embodiment, a problem to be solved in the present application comprises: how to receive the first physical-layer control information on the first physical-layer channel.

In one embodiment, characteristics of the above method comprise: the present application introduces a second identifier, which is used to generate at least one of a scrambling code sequence of the first physical-layer channel or an RS sequence of a DMRS of the first physical-layer channel, regardless of which identifier the given identifier is among multiple identifiers, thereby solving the above problem.

In one embodiment, characteristics of the above method comprise: the first node can avoid re-searching for a synchronization signal when performing cell switching between multiple cells indicated by the multiple identifiers.

In one embodiment, characteristics of the above method comprise: the first physical-layer channel comprises a PDCCH scheduling SIB1.

In one embodiment, characteristics of the above method comprise: the multiple identifiers comprise the second identifier.

In one embodiment, characteristics of the above method comprise: the multiple identifiers do not comprise the second identifier.

In one embodiment, characteristics of the above method comprise: the second identifier is not indicated by a synchronization signal.

In one embodiment, advantages of the above method comprise: obtaining a diversity gain of CORESET (Control Resource Set) #0.

In one embodiment, advantages of the above method comprise: increasing the scheduling flexibility.

In one embodiment, advantages of the above method comprise: decoupling at least one of a scrambling sequence of a physical-layer channel and a DMRS sequence of a physical-layer channel from a first identifier, making the scheduling more flexible.

In one embodiment, advantages of the above method comprise: the multiple identifiers comprising the second identifier can improve transmission reliability and efficiency.

In one embodiment, advantages of the above method comprise: the multiple identifiers not comprising the second identifier can avoid conflicts and confusion among cell identifiers, reducing the impact on cell switching and camping.

According to one aspect of the present application, the above method is characterized in that the first node is a UE.

According to one aspect of the present application, the above method is characterized in that the first node is a relay node.

The present application provides a method in a second node for power control in wireless communications, comprising:
transmitting a first reference signal; and the first reference signal being a synchronization signal indicating a first identifier, or the first reference signal being spatially correlated with a synchronization signal indicating a first identifier; and
receiving a first radio signal on a first cell;
herein, a first PL is obtained by a transmitter of the first radio signal according to a measurement for the first reference signal; the first radio signal is transmitted adopting first power; the calculating first power depends on the first PL and a first parameter value; the first parameter value depends on the first identifier associated with the first reference signal.

According to one aspect of the present application, the above method is characterized in that the first identifier associated with the first reference signal is a first candidate identifier, and the first parameter value is a first candidate parameter value; or, the first identifier associated with the first reference signal is a second candidate identifier, and the first parameter value is a second candidate parameter value.

According to one aspect of the present application, the above method is characterized in that the first power is linearly correlated with a product of the first PL and the first parameter value.

According to one aspect of the present application, the above method is characterized in that the first power is linearly correlated with a product of the first PL and a first coefficient, and the first power is linearly correlated with the first parameter value, and the first parameter value is used to determine expected power.

According to one aspect of the present application, the above method is characterized in comprising:
transmitting a first signaling;
herein, the first signaling indicates the first identifier.

According to one aspect of the present application, the above method is characterized in comprising:
transmitting a first broadcast signal;
herein, the first broadcast signal indicates multiple identifiers; the first identifier is one of the multiple identifiers.

According to one aspect of the present application, the above method is characterized in comprising:
transmitting first physical-layer control information;
herein, the given identifier is any one of the multiple identifiers, and the first physical-layer control information occupies a first physical-layer channel, regardless of which of the multiple identifiers the given identifier is, a second identifier is used to generate at least one of a scrambling sequence of the first physical-layer channel or an RS sequence of a DMRS of the first physical-layer channel.

According to one aspect of the present application, the above method is characterized in that the second node is a base station.

According to one aspect of the present application, the above method is characterized in that the second node is a UE.

According to one aspect of the present application, the above method is characterized in that the second node is a serving cell.

According to one aspect of the present application, the above method is characterized in that the second node is a serving cell of the first node.

According to one aspect of the present application, the above method is characterized in that the second node is a relay node.

The present application provides a device in a first node for power control in wireless communications, comprising:
a first receiver, measuring a first reference signal to obtain a first PL; the first reference signal being a synchronization signal indicating a first identifier, or the first reference signal being spatially correlated with a synchronization signal indicating a first identifier; and
a first transmitter, calculating first power, adopting the first power to transmit a first radio signal on a first cell;
herein, the calculating first power depends on the first PL and a first parameter value; the first parameter value depends on the first identifier associated with the first reference signal.

The present application provides a device in a second node for power control in wireless communications, comprising:
a second transmitter, transmitting a first reference signal; the first reference signal being a synchronization signal indicating a first identifier, or the first reference signal being spatially correlated with a synchronization signal indicating a first identifier; and
a second receiver, receiving a first radio signal on a first cell;
herein, a first PL is obtained by a transmitter of the first radio signal according to a measurement for the first reference signal; the first radio signal is transmitted adopting first power; the calculating first power depends on the first PL and a first parameter value; the first parameter value depends on the first identifier associated with the first reference signal.

In one embodiment, compared to conventional solutions, the present application has the following favorable, but not limited, advantages:
supporting RIS technology, which has the advantages of eliminating coverage blind spots, enhancing edge coverage, and increasing rank through multi-stream transmission;
facilitating the system to adjust the uplink transmission power appropriately, reducing power adjustment delay, and improving system stability;
adjusting transmit power of uplink radio signals more precisely, ensuring reliable transmission of signals while reducing power consumption of the terminal;
being conducive to enhancing coverage range, and improving the service quality and expanding coverage of the system.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a first flowchart of transmission between a first node and a second node according to one embodiment of the present application;

FIG. 6 illustrates another flowchart of transmission between a first node and a second node according to one embodiment of the present application;

FIG. 7 illustrates a schematic diagram of a first identifier according to one embodiment of the present application;

FIG. 8 illustrates a schematic diagram of a first candidate parameter value and a second candidate parameter value according to one embodiment of the present application;

FIG. 9 illustrates a structure block diagram of a processor in a first node according to one embodiment of the present application;

FIG. 10 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmission of a first node according to one embodiment of the present application, as shown in FIG. 1. In FIG. 1, each block represents a step. And in particular, the order of steps in boxes does not represent a chronological order of characteristics between the steps.

A first node measures a first reference signal to obtain a first PL in step 101; the first reference signal is a synchronization signal indicating a first identifier, or the first reference signal is spatially correlated with a synchronization signal indicating a first identifier; and calculates first power in step 102, adopts the first power to transmit a first radio signal on a first cell.

In embodiment 1, the calculating first power depends on the first PL and a first parameter value; the first parameter value depends on the first identifier associated with the first reference signal.

In one embodiment, the measuring a first reference signal comprises obtaining RSRP (Reference Signal Receiving Power) of the first reference signal.

In one subembodiment of the above embodiment, the RSRP of the first reference signal is a higher-layer filtered RSRP.

In one embodiment, the measuring a first reference signal comprises obtaining receiving power of the first reference signal.

In one embodiment, the first PL is measured by dB (deciBel).

In one embodiment, the first PL is obtained by subtracting RSRP of the first reference signal from transmit power of the first reference signal.

In one embodiment, the first PL is obtained by subtracting receive power of the first reference signal from transmit power of the first reference signal.

In one embodiment, the first PL is downlink.

In one embodiment, the first PL is estimated by the first node.

In one embodiment, the RSRP of the first reference signal is RSRP of higher-layer filtering.

In one embodiment, RSRP of the first reference signal comprises Layer 3 (L3) filtered RSRP.

In one embodiment, the RSRP of the first reference signal comprises L3-RSRP.

In one embodiment, the first reference signal is a downlink RS (Reference Signal).

In one embodiment, the transmit power of the first reference signal is a linear average value of a power contribution of all Resource Elements (REs) carrying the first reference signal within an operating system bandwidth.

In one embodiment, the transmit power of the first reference signal is a linear average value of a power contribution of REs carrying the configured first reference signal within an operating system bandwidth.

In one embodiment, the transmit power of the first reference signal is higher-layer signaling configured.

In one embodiment, the transmit power of the first reference signal is RRC (Radio Resource Control) signaling configured.

In one embodiment, the transmit power of the first reference signal is higher-layer signaling indicated.

In one embodiment, the transmit power of the first reference signal is RRC-signaling indicated.

In one embodiment, when the first reference signal is a synchronization signal indicating the first identifier, the first reference signal comprises a PSS (Primary Synchronization Signal).

In one embodiment, when the first reference signal is a synchronization signal indicating the first identifier, the first reference signal comprises an SSS (Secondary Synchronization Signal).

In one embodiment, when the first reference signal is a synchronization signal indicating the first identifier, the first reference signal comprises a PBCH (Physical Broadcast Channel).

In one embodiment, when the first reference signal is a synchronization signal indicating the first identifier, the first reference signal comprises a DMRS (DeModulation Reference Signal) of PBCH.

In one embodiment, when the first reference signal is a synchronization signal indicating the first identifier, the first reference signal comprises an SSB.

In one embodiment, when the first reference signal is spatially correlated with a synchronization signal indicating a first identifier, the first reference signal comprises a CSI-RS.

In one embodiment, when the first reference signal is spatially correlated with a synchronization signal indicating a first identifier, the first reference signal comprises an RS used for channel state information reporting.

In one embodiment, when the first reference signal is spatially correlated with a synchronization signal indicating a first identifier, the first reference signal comprises a DMRS.

In one embodiment, when the first reference signal is spatially correlated with a synchronization signal indicating a first identifier, the first reference signal comprises an RS used for channel demodulation.

In one embodiment, the SSB in the present application refers to: a Synchronization Signal Block.

In one embodiment, the SSB in the present application refers to: an SS (Synchronization Signal)/PBCH (Physical Broadcast Channel) block.

Typically, receiving occasions of PBCH, PSS, SS are in continuous symbols, and form an SS/PBCH block.

In one embodiment, the first reference signal is spatially correlated with a synchronization signal indicating the first identifier.

In one embodiment, the first reference signal corresponds to a reference signal index.

In one embodiment, the first reference signal corresponds to a reference signal identifier.

In one embodiment, the first reference signal corresponds to a reference signal identity.

In one embodiment, the first reference signal is indicated by a reference signal index.

In one embodiment, the first reference signal is indicated by a reference signal identifier.

In one embodiment, the first reference signal is indicated by a reference signal identity.

In one embodiment, the first reference signal corresponds to a reference signal resource index.

In one embodiment, the first reference signal corresponds to a reference signal resource identifier.

In one embodiment, the first reference signal corresponds to a reference signal resource identity.

In one embodiment, the first reference signal is indicated by a reference signal resource index.

In one embodiment, the first reference signal is indicated by a reference signal resource identifier.

In one embodiment, the first reference signal is indicated by a reference signal resource identity.

In one embodiment, the first reference signal corresponds to a reference signal resource set index.

In one embodiment, the first reference signal corresponds to a reference signal resource set identifier.

In one embodiment, the first reference signal corresponds to a reference signal resource set identity.

In one embodiment, the first reference signal is indicated by a reference signal resource index set.

In one embodiment, the first reference signal is indicated by a reference signal resource identifier set.

In one embodiment, the first reference signal is indicated by a reference signal resource identity set.

In one embodiment, the first reference signal is a transmission of a reference signal resource.

In one subembodiment of the embodiment, the reference signal resource is periodic.

In one subembodiment of the embodiment, the reference signal resource is Semi-Persistent (SP).

In one subembodiment of the embodiment, the reference signal resource is APersistent (AP).

In one embodiment, when the first reference signal is spatially correlated with a synchronization signal indicating a first identifier, the first reference signal is broadcast.

In one subembodiment of the embodiment, advantages of the above method include: expanding the coverage area of the cell and enhancing the coverage capability at the cell edges.

In one embodiment, when the first reference signal is spatially correlated with a synchronization signal indicating a first identifier, the first reference signal is unicast.

In one subembodiment of the embodiment, advantages of the above method include: saving system resources while providing more accurate channel estimation and synchronization timing.

In one embodiment, the meaning of two signals being spatially correlated in the present application comprises: two signals being QCLed.

In one embodiment, the meaning of two signals being spatially correlated in the present application comprises: two signals correspond to a same TCI (Transmission Configuration Indicator).

In one embodiment, the meaning of two signals being spatially correlated in the present application comprises: two signals correspond to a same TCI-State.

In one embodiment, the meaning of two signals being spatially correlated in the present application comprises: two signals correspond to a same TCI-StateId.

In one embodiment, the meaning of two signals being spatially correlated in the present application comprises: two signals adopt a same spatial Tx parameter.

In one embodiment, the meaning of two signals being spatially correlated in the present application comprises: two signals adopt a same spatial Rx parameter.

In one embodiment, the meaning of two signals being spatially correlated in the present application comprises: two signals use a same spatial filtering.

In one embodiment, the meaning of two signals being spatially correlated in the present application comprises: two signals use a same spatial-domain filtering.

In one embodiment, the meaning of two signals being spatially correlated in the present application comprises: large-scale properties to which one of the two signals is conveyed can be used to infer large-scale properties to which the other one of the two signals is conveyed.

In one embodiment, the meaning of the two signals being spatially correlated in the present application comprises: two signals are QCLed and their corresponding QCL types comprise typeD.

In one embodiment, the meaning of the two signals being spatially correlated in the present application comprises: two signals are QCLed and corresponding QCL types comprise a QCL type other than typeA, typeB, typeC, and typeD.

In one embodiment, the QCL in the present application refers to: Quasi Co-Location.

In one embodiment, the QCL in the present application refers to: Quasi Co-Located.

In one embodiment, the QCL in the present application comprises QCL parameters.

In one embodiment, the QCL in the present application comprises a QCL assumption.

In one embodiment, the QCL types in the present application comprise TypeA, TypeB, TypeC, and TypeD.

In one embodiment, the QCL types in the present application comprise a QCL type other than TypeA, TypeB, TypeC, and TypeD.

In one embodiment, QCL parameters with the QCL type being TypeA in the present application comprise Doppler shift, Doppler spread, average delay and delay spread; QCL parameters with the QCL type being TypeB comprise Doppler shift and Doppler spread; QCL parameters with the QCL type being TypeC comprise Doppler shift and average delay; QCL parameters with the QCL type being TypeD comprise spatial Rx parameter.

In one embodiment, the QCL in the present application comprises at least one of Doppler shift, Doppler spread, average delay, delay spread, Spatial Tx parameter or Spatial Rx parameter.

In one embodiment, for specific definitions of the TypeA, the TypeB, the TypeC and the TypeD in the present application, refer to clause 5.1.5 of 3GPP TS 38.214.

In one embodiment, the Spatial Tx parameters in the present application comprise at least one of a transmitting antenna port, a transmitting antenna port group, a transmitting beam, a transmitting analog beamforming matrix, a transmitting analog beamforming vector, a transmitting beamforming matrix, a transmitting beamforming vector or a spatial-domain transmission filter.

In one embodiment, the Spatial Rx parameters in the present application comprise at least one of a receiving beam, a receiving analog beamforming matrix, a receiving analog beamforming vector, a receiving beamforming matrix, a receiving beamforming vector or a spatial-domain reception filter.

In one embodiment, the first identifier is a non-negative integer.

In one embodiment, the first identifier is a value between 0 and 1007.

In one embodiment, the first identifier is a synchronization signal index.

In one embodiment, the first identifier is a synchronization signal identifier.

In one embodiment, the first identifier is a synchronization signal identity.

In one embodiment, the first identifier corresponds to multiple synchronization signal indexes.

In one embodiment, the first identifier corresponds to multiple synchronization signal identifiers.

In one embodiment, the first identifier corresponds to multiple synchronization signal identities.

In one embodiment, the first identifier is an SSI.

In one embodiment, the SSI in the present application refers to: Synchronization Signal Index.

In one embodiment, the SSI in the present application refers to: Synchronization Signal Identity.

In one embodiment, the first identifier is a physical cell identifier.

In one embodiment, the first identifier is a PCI.

In one embodiment, the PCI in the present application refers to: Physical Cell Identifier.

In one embodiment, the PCI in the present application refers to: Physical Cell Identity.

In one embodiment, the PCI in the present application refers to: Physical-layer Cell Identity.

In one embodiment, the PCI in the present application refers to: physCellId.

In one embodiment, the first identifier is used to identify a cell.

In one embodiment, the first identifier is used to indicate a cell.

In one embodiment, the first identifier is used to identify an RIS device.

In one embodiment, the first identifier is used to identify a base station, or the first identifier is used to identify an RIS device.

In one embodiment, the first cell is a serving cell.

In one embodiment, the first identifier is for the first cell.

In one embodiment, the RIS in the present application refers to: Reconfigurable Intelligent Surface.

In one embodiment, the RIS in the present application refers to: Intelligent Reflecting Surface.

In one embodiment, the synchronization signal in the present application comprises at least a synchronization signal in a system after 5G system.

In one embodiment, the synchronization signal in the present application comprises at least a synchronization signal in 6G system.

In one embodiment, the first reference signal explicitly or implicitly indicate the first identifier.

In one subembodiment of the above embodiment, the first identifier can be accurately and unambiguously obtained according to the first reference signal.

In one subembodiment of the above embodiment, the explicitly indicating comprises: directly indicating.

In one subembodiment of the above embodiment, the explicitly indicating comprises: the first identifier is calculated according to a sequence of the first reference signal.

In one subembodiment of the above embodiment, the explicitly indicating comprises: the first identifier is calculated according to a sequence of the first reference signal and other predefined configurations.

In one subembodiment of the above embodiment, the first identifier can be accurately and unambiguously obtained according to a synchronization signal spatially correlated with the first reference signal.

In one subembodiment of the above embodiment, the implicitly indicating comprises: being indicated through other spatially-correlated synchronization signals.

In one subembodiment of the above embodiment, the implicitly indicating comprises: the first identifier is calculated according to a sequence of a synchronization signal spatially correlated with the first reference signal.

In one subembodiment of the above embodiment, the implicitly indicating comprises: the first identifier is calculated according to a sequence of a synchronization signal spatially correlated with the first reference signal and other predefined configurations.

In one embodiment, a physical-layer channel occupied by the first radio signal comprises a PUSCH (Physical Uplink Shared Channel).

In one embodiment, a physical-layer channel occupied by the first radio signal comprises a Physical Uplink Control Channel (PUCCH).

In one embodiment, a transmission channel occupied by the first radio signal comprises a UL-SCH (Uplink Control Channel).

In one embodiment, the first radio signal comprises a radio frequency signal.

In one embodiment, the first radio signal comprises a reference signal.

In one embodiment, the first radio signal comprises a Sounding Reference Signal (SRS).

In one embodiment, the first radio signal comprises a DMRS (Demodulation Reference Signal).

In one embodiment, the first radio signal comprises Uplink control information (UCI).

In one embodiment, the first radio signal comprises a HARQ (Hybrid Automatic Repeat reQuest)-ACK (ACKnowledgement).

In one embodiment, the first radio signal carries a bit block, the bit block comprises at least one TB (Transport Block) or at least one CBG (Code Block Group).

In one embodiment, the first radio signal is based on dynamically-scheduled PUSCH transmission.

In one embodiment, the first radio signal is a configured-grant PUSCH transmission.

In one embodiment, the first radio signal is a codebook-based PUSCH transmission.

In one embodiment, the first radio signal is a non-codebook-based PUSCH transmission.

In one embodiment, the first radio signal is for a PUCCH transmission of a dynamic signaling.

In one embodiment, the first radio signal is not for a PUCCH transmission of a dynamic signaling.

In one embodiment, the first radio signal is transmitted on BWP (Band Width Part) b of carrier f of serving cell c at transmission occasion i.

In one embodiment, the first radio signal is transmitted using a parameter set configuration indexed as j on BWP b of carrier f of serving cell c at transmission occasion i.

In one embodiment, the first radio signal is transmitted using power control adjustment state indexed as l on BWP b of carrier f of serving cell c at transmission occasion i.

In one subembodiment of the above three embodiments, the serving cell c is the first cell in the present application.

In one embodiment, the meaning of transmitting a first radio signal on the first cell comprises: using radio resources of the first cell to transmit the first radio signal.

In one embodiment, the meaning of transmitting a first radio signal on the first cell comprises: transmitting the first radio signal in radio resources corresponding to the first cell.

In one embodiment, the meaning of transmitting a first radio signal on the first cell comprises: transmitting the first radio signal in radio resources configured for the first cell.

In one embodiment, the radio resources in the present application comprise frequency-domain resources.

In one embodiment, the radio resources in the present application comprise time-domain resources.

In one embodiment, the radio resources in the present application comprise code-domain resources.

In one embodiment, the radio resources in the present application comprise spatial-domain resources.

In one embodiment, the radio resources in the present application comprise power resources.

In one embodiment, the radio resources in the present application comprise a transmission occasion.

In one embodiment, the meaning of calculating first power depending on the first PL and a first parameter value comprises: the first power is linearly correlated with the first PL, and the first power is linearly correlated with the first parameter value.

In one embodiment, the meaning of calculating the first power depending on an accumulation of the first PL and at least one power offset comprises: the first power increases and decreases as the first PL increases and decreases, and the first power increases and decreases as the first parameter value increases and decreases.

In one embodiment, the meaning of the first parameter value depending on the first identifier associated with the first reference signal comprises: the first identifier is one of K1 identifiers, where K1 is a positive integer greater than 1; the K1 identifiers are respectively associated with K1 candidate parameter values, and the first parameter value is a candidate parameter value associated with the first identifier in the K1 candidate parameter values.

In one embodiment, the meaning of the first parameter value depending on the first identifier associated with the first reference signal comprises: when the first identifier associated with the first reference signal is reconfigured, the first parameter value changes accordingly.

In one embodiment, the meaning of the first parameter value depending on the first identifier associated with the first reference signal comprises: when the first identifier associated with the first reference signal changes, the first parameter value changes accordingly.

In one embodiment, the first power is measured by dBm (deciBel relative to one milliwatt).

In one embodiment, the first power is measured by mW (milliWatt).

In one embodiment, the first power is measured by W (Watt).

In one embodiment, an upper limit value of the first power is a maximum transmit power value of the first radio signal configured by the first node.

In one embodiment, an upper limit of the first power is maximum output power configured by the first node.

In one embodiment, an upper limit value of the first power is maximum output power of the first cell configured by the first node for a carrier.

In one embodiment, an upper limit of the first power is related to a capability of the first node.

In one embodiment, an upper limit value of the first power is related to a Category of the first node.

In one embodiment, an upper limit value of the first power corresponds to P_{CMAX,f,c}(i) in 3GPP protocol.

In one embodiment, the first cell is a serving cell.

In one embodiment, the serving cell in the present application is a Primary Cell (PCell).

In one embodiment, the serving cell in the present application is a Secondary Cell (SCell).

In one embodiment, the serving cell in the present application is a Special Cell (SpCell).

In one embodiment, the serving cell in the present application is a Master Cell group (MCG).

In one embodiment, the serving cell in the present application is an SCG (Secondary cell group).

### Embodiment 2

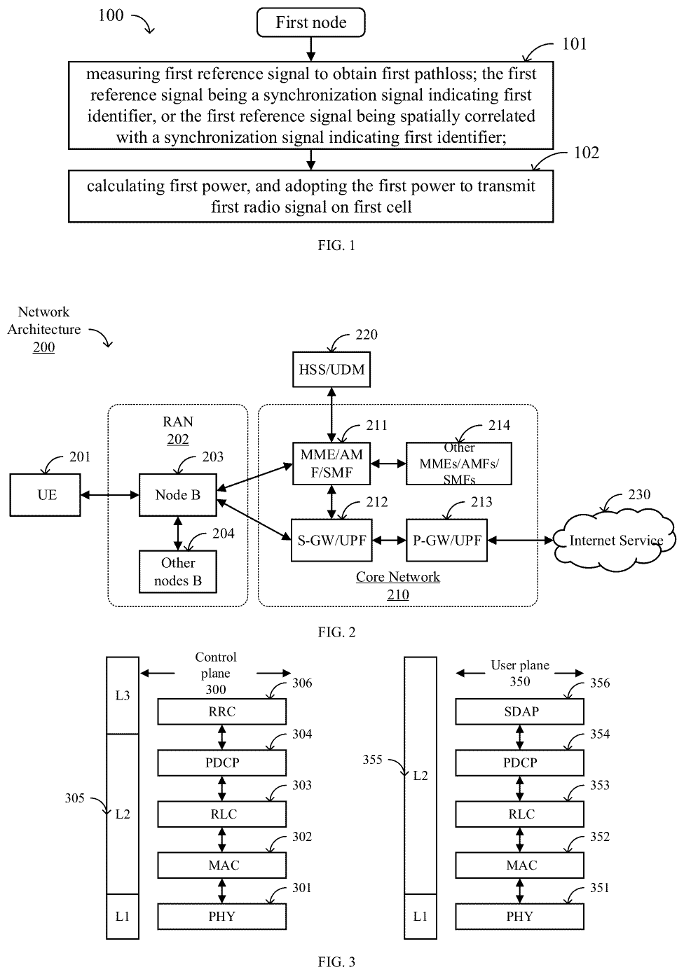

Embodiment 2 illustrates a schematic diagram of a network architecture according to one embodiment of the present application, as shown in FIG. 2.

FIG. 2 illustrates the network architecture 200. The network architecture 200 refers to the network architecture of LTE (Long Term Evolution), LTE-A (Long Term Evolution Advanced), 5G system, 5G Advanced, and future 6G system. The network architecture of LTE, LTE-A, 5G systems, 5G Advanced, and future 6G systems is called EPS (Evolved Packet System). The 5G NR or LTE network architecture may be called a 5G System (5GS)/Evolved Packet System (EPS) or other appropriate terms; the 6G network architecture can be referred to as 6GS (6G System)/EPS or some other appropriate terminology. The network architecture 200 may include one or more UEs 201, RAN (Next Generation Radio Access Network) 202, core network 210, HSS (Home subscriber server)/UDM (Unified Data Management) 220, and Internet service 230. The network architecture 200 may be interconnected with other access networks. For simple description, the entities/interfaces are not shown. As shown in FIG. 2, the network architecture 200 provides packet switching services. Those skilled in the art will find it easy to understand that various concepts presented throughout the present application can be extended to networks providing circuit switching services. RAN 202 comprises Node B 203 and other nodes 204. The node 203 provides UE 201-oriented user plane and control plane protocol terminations. The node 203 can be connected to other nodes 204 via Xn interface (e.g., backhaul). The node 203 may also be referred to as a base station, base transceiver station, radio base station, radio transceiver, transceiver function, Basic Service Set (BSS), Extended Service Set (ESS), TRP (Transmitter Receiver Point), or some other suitable terms. The node 203 provides UE 201 with an access point to the core network 210; the core network 210 is 5GC (5G Core Network)/EPC (Evolved Packet Core), or, the core network 210 is 6GC. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), air vehicles, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. Node 203 is connected to core network 210 through S1/NG interface. Core network 210 includes MME (Mobility Management Entity)/AMF (Authentication Management Field)/SMF (Session Management Function) 211, other MME/AMF/SMF 214, S-GW (Service Gateway)/UPF (User Plane Function) 212, and P-GW (Packet Date Network Gateway)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. Internet Services 230 includes operator-corresponding Internet Protocol services, which may specifically include Internet, Intranet, IMS (IP Multimedia Subsystem) and packet switching services.

In one embodiment, the first node in the present application comprises the UE 201.

In one embodiment, the second node in the present application comprises the node 203.

In one embodiment, the second node in the present application comprises the node 204.

In one embodiment, the UE 201 comprises a mobile phone.

In one embodiment, the UE 201 is a vehicle comprising a car.

In one embodiment, the node 203 is a Marco Cell base station.

In one embodiment, the node 203 is a Micro Cell base station.

In one embodiment, the node 203 is a Pico Cell base station.

In one embodiment, the node 203 is a Femtocell.

In one embodiment, the node 203 is a base station that supports large delay differences.

In one embodiment, the node 203 is a flight platform.

In one embodiment, the node 203 is satellite equipment.

In one embodiment, the node 203 is a test device (e.g., a transceiver device simulating some functions of a base station, a signaling tester).

In one embodiment, the node 204 is a macro cell base station.

In one embodiment, the node 204 is a microcell base station.

In one embodiment, the node 204 is a Pico Cell base station.

In one embodiment, the node 204 is a Femtocell.

In one embodiment, the node 204 is a base station that supports large delay differences.

In one embodiment, the node 204 is a flight platform.

In one embodiment, the node 204 is satellite equipment.

In one embodiment, the node 204 is a test device (e.g., a transceiver device simulating some functions of a base station, a signaling tester).

In one embodiment, the node 203 is a relay node device.

In one embodiment, the node 204 is an RIS device.

In one embodiment, the node 203 and the node 204 are a same node.

In one embodiment, the node 203 and the node 204 are two different nodes.

In one embodiment, the relay node device comprises a relay.

In one embodiment, the relay node device comprises an L3 relay.

In one embodiment, the relay node device comprises an L2 relay.

In one embodiment, the relay node device comprises a router.

In one embodiment, the relay node device comprises a switch.

In one embodiment, the relay node device comprises a UE.

In one embodiment, the relay node device comprises a base station.

In one embodiment, the relay node device comprises an RIS.

In one embodiment, a radio link from the UE 201 to the node 203 is an uplink, and the uplink is used for executing an uplink transmission.

In one embodiment, a radio link from the node 203 to the UE 201 is a downlink, and the downlink is used for executing a downlink transmission.

In one embodiment, a radio link between the UE 201 and the node 203 comprises a cellular network link.

In one embodiment, the UE 201 and the node 203 are connected via a Uu air interface.

In one embodiment, a transmitter of the first reference signal comprises the node 203.

In one embodiment, a receiver of the first reference signal comprises the UE 201.

In one embodiment, a transmitter of the first reference signal comprises the node 204.

In one embodiment, a receiver of the first reference signal comprises the UE 201.

In one embodiment, a transmitter of the first signaling comprises the node 203.

In one embodiment, a receiver of the first signaling comprises the UE 201.

In one embodiment, a transmitter of the first radio signal comprises the UE 201.

In one embodiment, a receiver of the first radio signal comprises the node 203.

In one embodiment, a transmitter of the first broadcast signal in the present application comprises the node 203.

In one embodiment, a receiver of the first broadcast signal in the present application comprises the UE 201.

In one embodiment, a transmitter of the first physical-layer control information in the present application comprises the node 203.

In one embodiment, a receiver of the first physical-layer control information in the present application comprises the UE 201.

In one embodiment, the UE 201 supports RIS.

In one embodiment, the node 203 supports RIS.

In one embodiment, the UE 201 supports 5G system.

In one embodiment, the UE 201 supports 6G system.

In one embodiment, the node 203 supports 6G system.

In one embodiment, the UE 201 at least supports 6G system.

In one embodiment, the node 203 at least supports 6G system.

In one embodiment, the UE 201 supports irregular coverage.

### Embodiment 3

Embodiment 3 illustrates a schematic diagram of a radio protocol architecture of a user plane and a control plane according to one embodiment of the present application, as shown in FIG. 3.

FIG. 3 is a schematic diagram illustrating an embodiment of the radio protocol architecture for user plane 350 and control plane 300. FIG. 3 shows a radio protocol architecture for a first communication node device (UE or RSU (Road Side Unit) in V2X (Vehicle to Everything), vehicle-mounted device or vehicle-mounted communication module) and a second node device (gNB, UE or RSU in V2X, vehicle-mounted device or vehicle-mounted communication module), or the control plane 300 between two UEs in three layers: Layer 1 (L1), Layer 2 (L2) and Layer 3 (L3). L1 is the lowest layer and implements various PHY (physical layer) signal processing functions. L1 will be referred to as PHY 301 in the present application. L2 305 is located above PHY 301 and is responsible for a link between the first node and the second node, or between two UEs, through the PHY 301. L2 305 includes MAC (Medium Access Control) sublayer 302, RLC (Radio Link Control) sublayer 303, and PDCP (Packet Data Convergence Protocol) sublayer 304, which terminate at the second node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of an upper-layer packet, retransmission of a lost packet, and reordering of a packet so as to compensate the disordered reception incurred by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 355 in the user plane 350 also includes Service Data Adaptation Protocol (SDAP) sublayer 356, which is responsible for the mapping between QoS (Quality of Service) flow and Data Radio Bearer (DRB) to support the diversity of traffic. Although not shown, the first communication node device has several upper layers above L2 355, including a network layer (e.g., IP (Internet Protocol) layer) terminating at the P-GW on the network side and an application layer terminating at the other end of the connection (e.g., remote UE, server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first reference signal is generated at the PHY 301 or the PHY 351.

In one embodiment, the first signaling is generated at the PHY 301 or the PHY 351.

In one embodiment, the first radio signal is generated at the PHY 301 or the PHY 351.

In one embodiment, the first radio signal is generated at the MAC 302 or the MAC 352.

In one embodiment, the first radio signal is generated at the RRC 306.

In one embodiment, the first broadcast signal in the present application is generated at the PHY 301 or the PHY 351.

In one embodiment, all of the first broadcast signal in the present application is generated at the PHY 301 or the PHY 351.

In one embodiment, part of the first broadcast signal in the present application is generated at the PHY 301 or the PHY 351.

In one embodiment, all of the first broadcast signal in the present application is generated at the RRC 306.

In one embodiment, part of the first broadcast signal in the present application is generated at the RRC 306.

In one embodiment, all of the first broadcast signal in the present application is generated at the MAC 302 or the MAC 352.

In one embodiment, part of the first broadcast signal in the present application is generated at the MAC 302 or the MAC 352.

In one embodiment, part of the first broadcast signal in the present application is generated at the PHY 301 or the PHY 351, and part is generated at higher layers.

In one embodiment, part of the first broadcast signal in the present application is generated at the PHY 301 or the PHY 351, and part is generated at the RRC 306.

In one embodiment, the first physical-layer control information in the present application is generated at the PHY 301 or the PHY 351.

In one embodiment, the higher layer in the present application refers to a layer above the physical layer.

In one embodiment, the higher layer in the present application comprises the MAC layer.

In one embodiment, the higher layer in the present application comprises the RRC layer.

### Embodiment 4

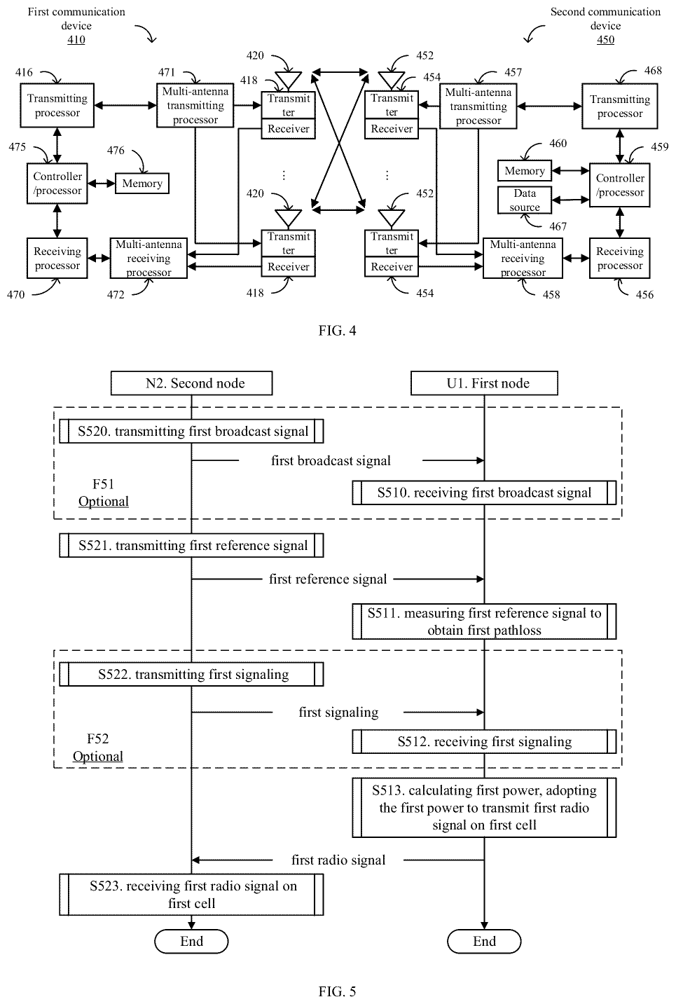

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 includes a controller/processor 475, a memory 476, a receiving processor 470, a transmitting processor 416, a multi-antenna receiving processor 472, a multi-antenna transmitting processor 471, a transmitter/receiver 418, and an antenna 420.

The second communication device 450 includes a controller/processor 459, a memory 460, a data source 467, a transmitting processor 468, a receiving processor 456, a multi-antenna transmitting processor 457, a multi-antenna receiving processor 458, a transmitter/receiver 454, and an antenna 452.

In a transmission from the first communication device 410 to the second communication device 450, at the first communication device 410, a higher-layer packet from the core network is provided to the controller/processor 475. The controller/processor 475 implements L2 functionality. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 (that is, PHY). The transmitting processor 416 implements encoding and interleaving to facilitate Forward Error Correction (FEC) at the second communication device 450, as well as mapping of signal clusters based on various modulation schemes such as Binary Phase Shift Keying (BPSK), Quadrature Phase Shift Keying (QPSK), M-ary Phase Shift Keying (M-PSK), and M-Quadrature Amplitude Modulation (M-QAM). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream to a subcarrier, multiplies the modulated symbols with a reference signal (e.g., pilot) in time domain and/or frequency domain, and subsequently uses an Inverse Fast Fourier Transform (IFFT) to generate a physical channel carrying a time-domain multi-carrier symbol stream. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives signals through its corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 implement various signal processing functions of L1. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2, or various control signals can be provided to the L3 layer for processing. The controller/processor 459 is also responsible for error detection using ACKnowledgement (ACK) and/or Negative ACKnowledgement (NACK) protocols to support HARQ operations.

In a transmission from the second communication device 450 to the first communication device 410, the data source 467 is used at the second communication device 450 to provide upper layer data packets to the controller/processor 459. The data source 467 represents all protocol layers above the L2. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 functions used for the user plane and the control plane. The controller/processor 459 is also responsible for HARQ operation, retransmission of a lost packet, and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function at the first communication device 410 is similar to the receiving function at the second communication device 450 described in a transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly implement the function of L1. The controller/processor 475 implements L2 function. The controller/processor 475 can be connected with the memory 476 that stores program code and data. The memory 476 can be called a computer readable medium. The controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least measures a first reference signal to obtain a first PL; the first reference signal is a synchronization signal indicating a first identifier, or the first reference signal is spatially correlated with a synchronization signal indicating a first identifier; and calculates first power, adopts the first power to transmit a first radio signal on a first cell; the calculating first power depends on the first PL and a first parameter value; the first parameter value depends on the first identifier associated with the first reference signal.

In one embodiment, the second communication device 450 comprises a memory that stores a computer readable instruction program. The computer readable instruction program generates an action when executed by at least one processor. The action includes: measuring a first reference signal to obtain a first PL; the first reference signal being a synchronization signal indicating a first identifier, or the first reference signal being spatially correlated with a synchronization signal indicating a first identifier; and calculating first power, adopting the first power to transmit a first radio signal on a first cell.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a first reference signal; the first reference signal is a synchronization signal indicating a first identifier, or the first reference signal is spatially correlated with a synchronization signal indicating a first identifier; and receives a first radio signal on a first cell; first PL is obtained by a transmitter of the first radio signal according to a measurement for the first reference signal; the first radio signal is transmitted adopting first power; the calculating first power depends on the first PL and a first parameter value; the first parameter value depends on the first identifier associated with the first reference signal.

In one embodiment, the first communication device 410 comprises a memory that stores a computer readable instruction program. The computer readable instruction program generates an action when executed by at least one processor. The action includes: transmitting a first reference signal; and the first reference signal being a synchronization signal indicating a first identifier, or the first reference signal being spatially correlated with a synchronization signal indicating a first identifier; and receiving a first radio signal on a first cell.

In one embodiment, the first node comprises the second communication device 450 in the present application.

In one embodiment, the second node in the present application comprises the first communication device 410.

In one embodiment, at least one of the antenna 420, the transmitter 418, the transmitting processor 416, the multi-antenna transmitting processor 471, the controller/processor 475, or the memory 476 is used to transmit a first reference signal; at least one of the antenna 452, the receiver 454, the receiving processor 456, the multi-antenna receiving processor 458, the controller/processor 459, the memory 460, or the data source 467 is used to receive a first reference signal, and the first reference signal is measured to obtain a first PL.

In one embodiment, at least one of the antenna 420, the transmitter 418, the transmitting processor 416, the multi-antenna transmitting processor 471, the controller/processor 475, or the memory 476 is used to transmit a first signaling; at least one of the antenna 452, the receiver 454, the receiving processor 456, the multi-antenna receiving processor 458, the controller/processor 459, the memory 460, or the data source 467 is used to receive a first signaling.

In one embodiment, at least one of the antenna 452, the transmitter 454, the multi-antenna transmitting processor 457, the transmitting processor 468, or the controller/processor 459 is used to calculate first power, and the first power is adopted to transmit a first radio signal on a first cell; at least one of the antenna 420, the receiver 418, the multi-antenna receiving processor 472, the receiving processor 470, or the controller/processor 475 is used to receive a first radio signal on a first cell.

In one embodiment, at least one of the antenna 420, the transmitter 418, the transmitting processor 416, the multi-antenna transmitting processor 471, the controller/processor 475, or the memory 476 is used to transmit the first broadcast signal in the present application; at least one of the antenna 452, the receiver 454, the receiving processor 456, the multi-antenna receiving processor 458, the controller/processor 459, the memory 460, or the data source 467 is used to receive the first broadcast signal in the present application.

In one embodiment, at least one of the antenna 420, the transmitter 418, the transmitting processor 416, the multi-antenna transmitting processor 471, the controller/processor 475, or the memory 476 is used to transmit the first physical-layer control information in the present application; at least one of the antenna 452, the receiver 454, the receiving processor 456, the multi-antenna receiving processor 458, the controller/processor 459, the memory 460, or the data source 467 is used to receive the first physical-layer control information in the present application.

### Embodiment 5

Embodiment 5 illustrates a first flowchart of transmission between a first node and a second node according to one embodiment of the present application. In FIG. 5, a first node U1 and a second node N2 are in communications via a radio link. It is particularly underlined that the order illustrated in the embodiment does not put constraints over sequences of signal transmissions and implementations. Any of the embodiments, subembodiments, and subsidiary embodiments of embodiment 5 can be applied to embodiment 6 without conflict; on the contrary, embodiments, sub-embodiments and subsidiary embodiments of embodiments 6 can be applied to embodiment 5 without conflict; in FIG. 5, steps in boxes F51 and F52 are optional.

The first node U1 receives a first broadcast signal in step S510; measures a first reference signal to obtain a first PL in step S511; receives a first signaling in step S512; calculates first power in step S513, and adopts the first power to transmit a first radio signal on a first cell.

The second node N2 transmits a first broadcast signal in step S520; transmits a first reference signal in step S521; transmits a first signaling in step S522; and receives a first radio signal on a first cell in step S523.

In embodiment 5, the first reference signal is a synchronization signal indicating a first identifier, or the first reference signal is spatially correlated with a synchronization signal indicating a first identifier; the calculating first power depends on the first PL and a first parameter value; the first parameter value depends on the first identifier associated with the first reference signal.

In one embodiment, the first node U1 is the first node in the present application.

In one embodiment, the second node N2 is the second node in the present application.

In one embodiment, an air interface between the second node N2 and the first node U1 comprises a radio interface between a base station and a UE.

In one embodiment, an air interface between the second node N2 and the first node U1 comprises a radio interface between a relay node and a UE.

In one embodiment, an air interface between the second node N2 and the first node U1 comprises a radio interface between a UE and a UE.

In one embodiment, the second node N2 is a maintenance base station of a serving cell of the first node U1.

In one embodiment, the second node N2 is a maintenance base station of the first cell.

In one embodiment, the second node N2 is a maintenance base station of a cell indicated by the first identifier.

In one embodiment, the second node N2 is a maintenance base station of a cell indicated by any one of the multiple identifiers.

In one embodiment, the step S511 of measuring a first reference signal to obtain a first PL comprises receiving the first reference signal.

Typically, the first power is linearly correlated with a product of the first PL and the first parameter value.

In one embodiment, the first parameter value corresponds to alpha.

In one embodiment, the first parameter value corresponds to α_{b,f,c}(j).

In one embodiment, the first parameter value is transmitted through an RRC signaling.

In one embodiment, the first parameter value is transmitted through an RRC IE.

In one embodiment, the first parameter value is transmitted through a PUSCH-PowerControl IE.

In one embodiment, the first parameter value is transmitted through a P0-PUSCH-AlphaSet field.

In one embodiment, a name of an RRC IE or RRC IE field used to configure the first parameter value comprises PUSCH.

In one embodiment, a name of an RRC IE or RRC IE field used to configure the first parameter value comprises PUCCH.

In one embodiment, a name of an RRC IE or RRC IE field used to configure the first parameter value comprises Power.

In one embodiment, a name of an RRC IE or RRC IE field used to configure the first parameter value comprises Control.

In one embodiment, a name of an RRC IE or RRC IE field used to configure the first parameter value comprises P0.

In one embodiment, a name of an RRC IE or RRC IE field used to configure the first parameter value comprises Alpha.

Typically, the first power is linearly correlated with a product of the first PL and a first coefficient, and the first power is linearly correlated with the first parameter value, and the first parameter value is used to determine expected power.

In one embodiment, the first parameter value corresponds to P0-PUSCH.

In one embodiment, the first parameter value corresponds to P_{O_UE_PUSCH,b,f,c}(j).

Typically, the first signaling indicates the first identifier.

In one embodiment, the first signaling comprises Downlink Control Information (DCI).

In one embodiment, the first signaling comprises a MAC CE (Control Element).

In one embodiment, the first signaling explicitly indicates the first identifier.

In one embodiment, the first signaling implicitly indicates the first identifier.

In one embodiment, the first signaling directly indicates the first identifier.

In one embodiment, the first signaling indirectly indicates the first identifier.

In one embodiment, the first signaling indicates that the first reference signal is associated with the first identifier.

In one embodiment, the first signaling indicates that the first reference signal is configured to be associated with the first identifier.

In one embodiment, the first signaling indicates that the first identifier is configured to the first reference signal.

In one embodiment, the first signaling indicates an index of a reference signal resource corresponding to the first reference signal.

In one embodiment, the first signaling indicates an identity of a reference signal resource corresponding to the first reference signal.

In one embodiment, an identifier associated with the first reference signal is one of K1 identifiers, K1 being a positive integer greater than 1, and the first signaling activates one of the K1 identifiers as the first identifier associated with the first reference signal.

Typically, the first broadcast signal indicates multiple identifiers; the first identifier is one of the multiple identifiers.

In one embodiment, the first broadcast signal comprises a Master Information Block (MIB).

In one embodiment, the first broadcast signal comprises a PBCH.

In one embodiment, the first broadcast signal explicitly indicates the multiple identifiers.

In one subembodiment of the above embodiment, the explicitly indicating comprises directly indicating.

In one subembodiment of the above embodiment, the explicitly indicating comprises directly indicating through code points.

In one embodiment, the first broadcast signal implicitly indicates the multiple identifiers.

In one embodiment, the first broadcast signal indicates a first value and multiple offset values, and the first value and a sum of the multiple offset values respectively generate the multiple identifiers.

In one embodiment, the first broadcast signal indicates a first value, and the first value and a sum of multiple offset values respectively generate the multiple identifiers, where the multiple offset values are fixed or predefined.

In one embodiment, the first broadcast signal comprises a higher-layer payload.

In one embodiment, the first broadcast signal comprises a physical-layer payload.

In one embodiment, the first broadcast signal comprises an index for each of the multiple identifiers.

In one embodiment, the first broadcast signal explicitly indicates the first identifier in the multiple identifiers.

In one subembodiment of the above embodiment, the explicitly indicating comprises an index of the first identifier in the multiple identifiers.

In one embodiment, the first broadcast signal explicitly indicates the second identifier in the present application in the multiple identifiers.

In one embodiment, the first broadcast signal explicitly indicates the second identifier in the present application in the multiple identifiers and the M1 in the present application.

In one embodiment, the first broadcast signal indicates a smallest identifier and a largest identifier in the multiple identifiers.

In one embodiment, a difference of any two of the multiple identifiers is equal.

In one embodiment, a difference of any two of the multiple identifiers is default.

In one embodiment, any one of the multiple identifiers is not less than the smallest identifier and not greater than the largest identifier.

In one embodiment, the first node receives the first broadcast signal during executing cell search procedure.

In one embodiment, the first node receives the first broadcast signal during executing synchronization procedure.

In one embodiment, the first reference signal comprises the first broadcast signal.

In one embodiment, the first reference signal indicates multiple identifiers.

In one embodiment, the first reference signal comprises the first broadcast signal, and the first broadcast signal indicates multiple identifiers.

In one embodiment, the multiple identifiers are the K1 identifiers in the present application.

In one embodiment, any one of the multiple identifiers is a non-negative integer.

In one embodiment, any one of the multiple identifiers is a value between 0 and 1007.

In one embodiment, any one of the multiple identifiers is a synchronization signal index.

In one embodiment, there at least exists one identifier in the multiple identifiers being a synchronization signal index.

In one embodiment, any one of the multiple identifiers is a synchronization signal identity.

In one embodiment, there at least exists one identifier in the multiple identifiers being a synchronization signal identity.

In one embodiment, any one of the multiple identifiers is a PCI.

In one embodiment, there at least exists one identifier in the multiple identifiers being PCI.

In one embodiment, any one of the multiple identifiers is used to identify a cell.

In one embodiment, there at least exists one identifier in the multiple identifiers being used to identify a cell.

In one embodiment, any one of the multiple identifiers is used to identify an RIS device.

In one embodiment, there at least exists one identifier in the multiple identifiers being used to identify an RIS device.

In one embodiment, there at least exists an identifier in the multiple identifiers being used to identify a base station, and there at least exists another identifier in the multiple identifiers being used to identify an RIS device.

In one embodiment, the multiple is two.

In one embodiment, the multiple is K1, K1 being a positive integer greater than 2.

In one embodiment, the multiple identifiers are indicated one by one by multiple fields, and names of the multiple fields are the same.

In one subembodiment of the above embodiment, the multiple fields respectively belong to multiple RRC IEs.

In one subembodiment of the above embodiment, the multiple fields belong to one RRC IE.

In one subembodiment of the above embodiment, the multiple fields respectively belong to multiple RRC signalings.

In one subembodiment of the above embodiment, the multiple fields belong to one RRC signaling.

In one embodiment, any one of the multiple identifiers indicates a cell.

In one embodiment, the multiple identifiers are all physical cell identifiers.

In one embodiment, the multiple identifiers correspond one-to-one with multiple synchronization signal sequences.

In one embodiment, the multiple identifiers respectively indicate multiple cells, and the multiple cells correspond to a same configuration of CORESET #0.

In one embodiment, steps in box F52 in FIG. 5 are taken before the step S511.

In one embodiment, steps in box F52 in FIG. 5 are taken before the step S521.

### Embodiment 6

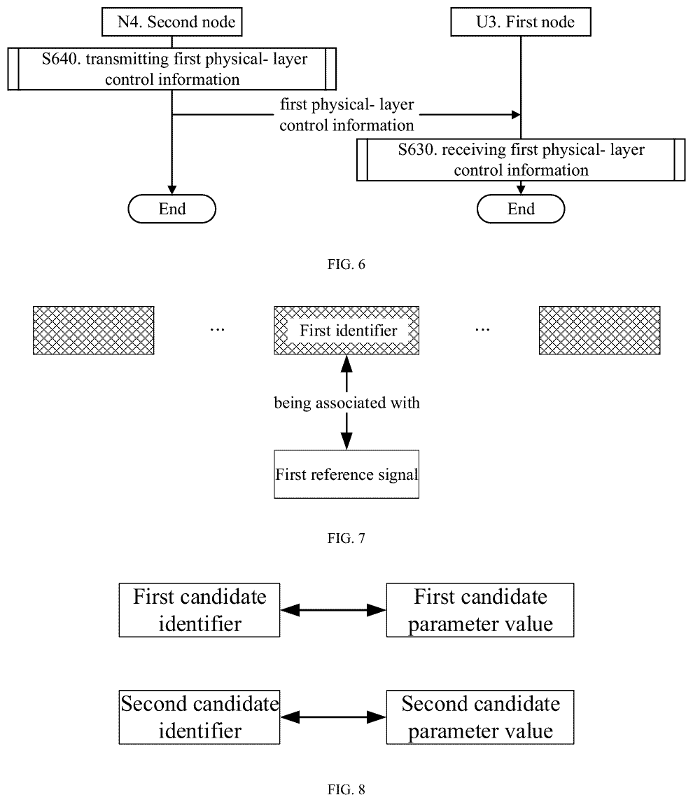

Embodiment 6 illustrates another flowchart of transmission between a first node and a second node according to one embodiment of the present application. In FIG. 6, a first node U3 and a second node N4 are in communications via a radio link. It is particularly underlined that the order illustrated in the embodiment does not put constraints over sequences of signal transmissions and implementations. Embodiments, sub-embodiments and subsidiary embodiments of embodiment 6 can be applied to embodiment 5 if no conflict is incurred. On the contrary, any of the embodiments, sub embodiments, and subsidiary embodiments in embodiment 5 can be applied to embodiment 6 without conflict.

The first node U3 receives first physical-layer control information in step S630.

The second node N4 transmits first physical-layer control information in step S640.

In embodiment 6, a given identifier is any one of the multiple identifiers, and the first physical-layer control information occupies a first physical-layer channel, regardless of which of the multiple identifiers the given identifier is, a second identifier is used to generate at least one of a scrambling sequence of the first physical-layer channel or an RS sequence of a DMRS of the first physical-layer channel.

In one embodiment, the first node U3 is the first node in the present application.

In one embodiment, the second node N4 is the second node in the present application.

In one embodiment, an air interface between the second node N4 and the first node U3 comprises a radio interface between a base station and a UE.

In one embodiment, an air interface between the second node N4 and the first node U3 comprises a radio interface between a relay node and a UE.

In one embodiment, an air interface between the second node N4 and the first node U3 comprises a radio interface between a UE and a UE.

In one embodiment, the second node N4 is a maintenance base station of a serving cell of the first node U3.

In one embodiment, the second node N4 is a maintenance base station of a cell indicated by the given identifier.

In one embodiment, the second node N4 is a maintenance base station of a cell indicated by any one of the multiple identifiers.

In one embodiment, the DMRS refers to: DeModulation Reference Signal.

In one embodiment, the RS refers to: Reference Signal.

In one embodiment, the first physical-layer control information is a bit transmitted on the first physical-layer channel.

In one embodiment, the first physical-layer control information is a bit carried by the first physical-layer channel.

In one embodiment, the first physical-layer control information is control information.

In one embodiment, the first physical-layer control information is DCI.

In one embodiment, the first physical-layer control information is generated at the physical layer.

In one embodiment, the meaning of transmitting a first radio signal on the first cell comprises: using radio resources of the first cell to receive the first physical-layer control information.

In one embodiment, the meaning of transmitting a first radio signal on the first cell comprises: receiving the first physical-layer control information in radio resources corresponding to the first cell.

In one embodiment, the meaning of transmitting a first radio signal on the first cell comprises: receiving the first physical-layer control information in radio resources configured for the first cell.

In one embodiment, the given identifier is any one of the multiple identifiers.

In one embodiment, the given identity is a non-negative integer.

In one embodiment, the given identifier is a value between 0 and 1007.

In one embodiment, the given identifier is a positive integer.

In one embodiment, the given identifier is equal to the first identifier.

In one embodiment, the given identifier is not equal to the first identifier.

In one embodiment, the given identifier is equal to the second identifier.

In one embodiment, the given identifier is not equal to the second identifier.

In one embodiment, the first physical-layer channel is a physical channel.

In one embodiment, the first physical-layer channel carries control information.

In one embodiment, the first physical-layer channel is a downlink channel.

In one embodiment, the first physical-layer channel only carries physical-layer control information.

In one embodiment, the first physical-layer channel is a PDCCH.

In one embodiment, the first physical-layer channel occupies physical-layer resources.

In one embodiment, the first physical-layer channel comprises a PDCCH that schedules SIB1.

In one embodiment, the first physical-layer channel consists of one or more Control Channel Elements (CCEs).

In one embodiment, the first node U3 receiving the first physical-layer channel is dependent on the first broadcast signal in the present application.

In one embodiment, the meaning of the first node U3 receiving the first physical-layer channel being dependent on the first broadcast signal in the present application comprises: the first broadcast signal in the present application is used to determine parameters of the first physical-layer channel.

In one embodiment, the meaning of the first node U3 receiving the first physical-layer channel being dependent on the first broadcast signal in the present application comprises: information indicated by the first broadcast signal in the present application is determined by the first node to determine parameters of the first physical-layer channel.

In one embodiment, the meaning of the first node U3 receiving the first physical-layer channel being dependent on the first broadcast signal in the present application comprises: the first broadcast signal in the present application indicates parameters of the first physical-layer channel.

In one embodiment, the meaning of the first node U3 receiving the first physical-layer channel being dependent on the first broadcast signal in the present application comprises: the first broadcast signal in the present application configures parameters of the first physical-layer channel.

In one embodiment, the meaning of the first node U3 receiving the first physical-layer channel being dependent on the first broadcast signal in the present application comprises: the first broadcast signal in the present application comprises a pdcch-ConfigSIB1, and the pdcch-ConfigSIB1 indicates parameters of the first physical-layer channel.

In one embodiment, the first node monitors the first physical-layer channel based on its parameters.

In one embodiment, the first node assumes that the first physical-layer channel adopts parameters of the first physical-layer channel.

In one embodiment, the first node uses parameters of the first physical-layer channel to monitor the first physical-layer channel.

In one embodiment, parameters of the first physical-layer channel comprise an index of CORESET #0 and an index of searchSpaceZero.

In one embodiment, parameters of the first physical-layer channel comprise a common CORESET.

In one embodiment, parameters of the first physical-layer channel comprise a common search space.

In one embodiment, parameters of the first physical-layer channel comprise time-domain resources and frequency-domain resources of the first physical-layer channel.

In one embodiment, parameters of the first physical-layer channel comprise a set of PDCCH candidates of the first physical-layer channel.

In one embodiment, parameters of the first physical-layer channel comprise PDCCH search space sets of the first physical-layer channel.

In one embodiment, the second identifier is a non-negative integer.

In one embodiment, the second identifier is a value between 0 and 1007.

In one embodiment, the second identifier is a positive integer.

In one embodiment, the second identifier is pre-defined.

In one embodiment, the second identifier is default.

In one embodiment, a type of the second identifier is different from a type of the first identifier.

In one embodiment, the second identifier is equal to the first identifier.

In one embodiment, the second identifier is not equal to the first identifier.

In one embodiment, the second identifier is not indicated by any synchronization signal.

In one embodiment, the second identifier is not indicated by any synchronization signal group.

In one embodiment, the second identifier is not indicated by any synchronization signal.

In one embodiment, the second identifier is not used to generate a synchronization signal sequence.

In one embodiment, the second identifier depends on the first identifier.

In one embodiment, the second identifier is a physical cell identifier.

In one embodiment, the second identifier is not a physical cell identifier.

In one embodiment, the second identifier is an SSI.

In one embodiment, the second identifier is not an SSI.

In one embodiment, the second identifier is a PCI.

In one embodiment, the second identifier is not a PCI.

In one embodiment, the second identifier is used to identify a cell.

In one embodiment, the second identifier is not used to identify a cell.

In one embodiment, the second identifier is used to indicate a cell.

In one embodiment, the second identifier is not used to indicate a cell.

In one embodiment, the second identifier is a reference cell identifier.

In one embodiment, the second identifier is a default cell identifier.

In one embodiment, the second identifier is determined by the given identifier.

In one subembodiment of the embodiment, the second identifier is determined by the multiple identifiers, and the given identifier is one of the multiple identifiers.

In one subembodiment of the embodiment, the second identifier depends on the multiple identifiers, and the given identifier is one of the multiple identifiers.

In one subembodiment of the embodiment, the second identifier depends on a number of identifiers comprised in the multiple identifiers.

In one embodiment, the second identifier is a predefined identifier in the multiple identifiers.

In one subembodiment of the embodiment, the second identifier is a smallest identifier in the multiple identifiers.

In one subsidiary embodiment of the above subembodiment, the second identifier is equal to a product of M1 multiplied by L; the multiple identifiers comprise M1 identifiers, where L is a quotient of the first identifier divided by M1, and the M1 identifiers are {M1×L, M1×L+1, M1×L+2, . . . , M1×L+M1−1}.

In one subembodiment of the embodiment, the second identifier is a largest identifier in the multiple identifiers.

In one subsidiary embodiment of the above subembodiment, the second identifier is equal to a product of M1 multiplied by L plus M1 then minus 1; the multiple identifiers comprise M1 identifiers, where L is a quotient of the first identifier divided by M1, and the M1 identifiers are {M1×L, M1×L+1, M1×L+2, . . . , M1×L+M1−1}.

In one embodiment, the second identifier is an identifier other than the multiple identifiers.

In one embodiment, the first broadcast information mentioned in the present application indicates the second identifier.

In one subembodiment of the above embodiment, the first broadcast information comprises the second identifier.

In one embodiment, the first broadcast information mentioned in the present application indicates the second identifier from the multiple identifiers.

In one subembodiment of the above embodiment, the first broadcast information explicitly indicates the second identifier.

In one subembodiment of the above embodiment, the first broadcast information implicitly indicates the second identifier.

In one subembodiment of the above embodiment, the first broadcast information comprises an index of the second identifier in the multiple identifiers.

In one embodiment, regardless of which of the multiple identifiers the given identifier is, the second identifier is used to generate a scrambling code sequence used for the first physical-layer channel.

In one embodiment, the meaning of the second identifier being used to generate a scrambling sequence of the first physical-layer channel comprises: the second identifier is used for a scrambling code sequence generator of the first physical-layer channel.

In one embodiment, the meaning of the second identifier being used to generate a scrambling sequence of the first physical-layer channel comprises: the second identifier is used for initializing a scrambling code sequence generator of the first physical-layer channel.

In one embodiment, the meaning of the second identifier being used to generate a scrambling sequence of the first physical-layer channel comprises: cᵢₙᵢₜ is used to generate a scrambling code sequence of the first physical-layer channel; herein, the cᵢₙᵢₜ depends on the second identifier.

In one embodiment, the meaning of the second identifier being used to generate a scrambling sequence of the first physical-layer channel comprises: a scrambling code sequence generator of the first physical-layer channel should be initialized as cᵢₙᵢₜ; herein, the second identifier is used to generate the cᵢₙᵢₜ.

In one embodiment, regardless of which of the multiple identifiers the given identifier is, the second identifier is used to generate an RS sequence of a DMRS of the first physical-layer channel.

In one embodiment, the second identifier being used to generate an RS sequence of a DMRS of the first physical-layer channel refers to: the second identifier is used for an RS sequence generator of a DMRS of the first physical-layer channel.

In one embodiment, the second identifier being used to generate an RS sequence of a DMRS of the first physical-layer channel refers to: the second identifier is used for initializing an RS sequence generator of a DMRS of the first physical-layer channel.

In one embodiment, the second identifier being used to generate an RS sequence of a DMRS of the first physical-layer channel refers to: cᵢₙᵢₜ is used to generate an RS sequence of a DMRS of the first physical-layer channel; herein, cᵢₙᵢₜ depends on the second identifier.

In one embodiment, the second identifier being used to generate an RS sequence of a DMRS of the first physical-layer channel refers to: an RS sequence generator of a DMRS of the first physical-layer channel should be initialized as cᵢₙᵢₜ; herein, cᵢₙᵢₜ depends on the second identifier.

In one embodiment, regardless of which of the multiple identifiers the given identifier is, the second identifier is used to generate a scrambling code sequence of the first physical-layer channel and an RS sequence of a DMRS of the first physical-layer channel.

In one embodiment, step S630 in FIG. 6 is taken after step S510 and before step S511 in FIG. 5.

In one embodiment, step S640 in FIG. 6 is taken after step S520 and before step S521 in FIG. 5.

In one embodiment, step S630 in FIG. 6 is taken after step S511 in FIG. 5.

In one embodiment, step S640 in FIG. 6 is taken after step S521 in FIG. 5.

In one embodiment, step S630 in FIG. 6 comprises step S512 in FIG. 5.

In one embodiment, step S640 in FIG. 6 comprises step S522 in FIG. 5.

### Embodiment 7

Embodiment 7 illustrates a schematic diagram of a first identifier according to one embodiment of the present application. In FIG. 7, the first reference signal is associated with a first identifier, and the first identifier is one of multiple identifiers. A rectangle filled with crossed diamonds in FIG. 7 represents one of multiple identifiers.

In one embodiment, the first reference signal corresponds to a reference signal resource index, and the reference signal resource index corresponding to the first reference signal is associated with the first identifier.

In one embodiment, the first reference signal corresponds to a reference signal resource identity, and the reference signal resource identity corresponding to the first reference signal is associated with the first identifier.

In one embodiment, the first identifier is equal to which one of the multiple identifiers is indicated by DCI.

In one embodiment, the first identifier is equal to which one of the multiple identifiers is indicated by MAC CE.

In one embodiment, the multiple identifiers are respectively used to indicate multiple nodes in the network.

In one subembodiment of the embodiment, the multiple nodes respectively correspond to multiple cells.

In one subembodiment of the embodiment, there at least exists one node in the multiple nodes being a base station.

In one subembodiment of the embodiment, there at least exists one node in the multiple nodes being an RIS.

In one subembodiment of the embodiment, there exists one node in the multiple nodes being a base station, and the other nodes being RIS.

### Embodiment 8

Embodiment 8 illustrates a schematic diagram of a relation of a first candidate parameter value and a second candidate parameter value according to one embodiment of the present application, as shown in FIG. 8. In FIG. 8, a first candidate identifier corresponds to the first candidate parameter value, and a second candidate identifier corresponds to the second candidate parameter value.

In Embodiment 8, the first candidate identifier is one of the multiple identifiers in the present application, and the second candidate identifier is an identifier in the multiple identifiers other than the first candidate identifier in the present application.

In one embodiment, the first candidate identifier is configured to a base station and the second candidate identifier is configured to an RIS device, or the first candidate identifier is configured to an RIS device and the second candidate identifier is configured to a base station.

In one embodiment, the first candidate identifier and the second candidate identifier are different.

In one embodiment, the first candidate parameter value and the second candidate parameter value are different.

In one embodiment, the first candidate parameter value and the second candidate parameter value are independently configured.

In one embodiment, the first candidate parameter value comprises a power control parameter.

In one embodiment, the second candidate parameter value comprises a power control parameter.

In one embodiment, the first candidate parameter value is expected power.

In one embodiment, the second candidate parameter value is expected power.

In one embodiment, the first candidate parameter value is p0.

In one embodiment, the second candidate parameter value is p0.

In one embodiment, the first candidate parameter value is Alpha.

In one embodiment, the second candidate parameter value is Alpha.

In one embodiment, the first candidate parameter value is used for PL compensation.

In one embodiment, the second candidate parameter value is used for PL compensation.

### Embodiment 9

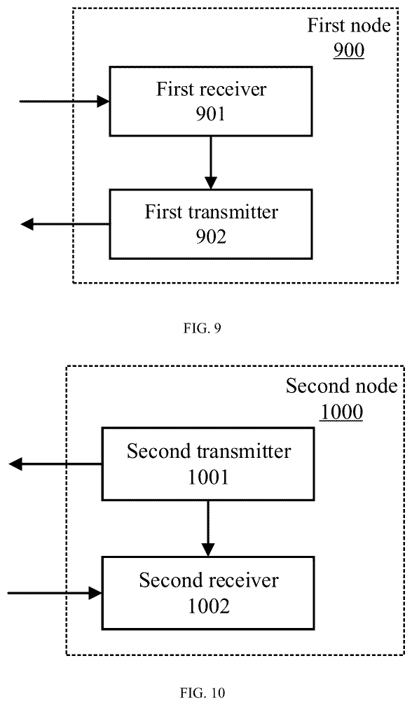

Embodiment 9 illustrates a structure block diagram of a processor of a first node, as shown in FIG. 9. In FIG. 9, a processor 900 of a first node comprises a first receiver 901 and a first transmitter 902.

In embodiment 9, the first receiver 901 measures a first reference signal to obtain a first pathloss; the first reference signal is a synchronization signal indicating a first identifier, or the first reference signal is spatially correlated with a synchronization signal indicating a first identifier; the first transmitter 902 calculates first power, and adopts the first power to transmit a first radio signal on a first cell;

in embodiment 9, the calculating first power depends on the first PL and a first parameter value; the first parameter value depends on the first identifier associated with the first reference signal.

In one embodiment, the first identifier associated with the first reference signal is a first candidate identifier, and the first parameter value is a first candidate parameter value; or, the first identifier associated with the first reference signal is a second candidate identifier, and the first parameter value is a second candidate parameter value.

In one embodiment, the first power is linearly correlated with a product of the first PL and the first parameter value.

In one embodiment, the first power is linearly correlated with a product of the first PL and a first coefficient, and the first power is linearly correlated with the first parameter value, and the first parameter value is used to determine expected power.

In one embodiment, comprising:
the first receiver 901 receives a first signaling;
herein, the first signaling indicates the first identifier.

In one embodiment, comprising:
the first receiver 901 receives a first broadcast signal;
herein, the first broadcast signal indicates multiple identifiers; the first identifier is one of the multiple identifiers.

In one embodiment, comprising:
the first receiver 901 receives first physical-layer control information;
herein, the given identifier is any one of the multiple identifiers, and the first physical-layer control information occupies a first physical-layer channel, regardless of which of the multiple identifiers the given identifier is, a second identifier is used to generate at least one of a scrambling sequence of the first physical-layer channel or an RS sequence of a DMRS of the first physical-layer channel.

In one embodiment, the first radio signal is transmitted on BWP (Band Width Part) b of carrier f of serving cell c at transmission occasion i, and the serving cell c is the first cell in the present application.

In one embodiment, the first radio signal is transmitted using a parameter set configuration indexed as j on BWP b of carrier f of serving cell c at transmission occasion i, and the serving cell c is the first cell in the present application.

In one embodiment, the first radio signal is transmitted using power control adjustment state indexed as l on BWP b of carrier f of serving cell c at transmission occasion i, and the serving cell c is the first cell in the present application.

In one embodiment, the synchronization signal in the present application comprises at least a synchronization signal in a system after 5G system.

In one embodiment, the synchronization signal in the present application comprises at least a synchronization signal in 6G system.

In one embodiment, the multiple identifiers correspond one-to-one with multiple synchronization signal sequences.

In one embodiment, the multiple identifiers respectively indicate multiple cells, and the multiple cells correspond to a same configuration of CORESET #0.

In one embodiment, there at least exists one identifier in the multiple identifiers being used to identify an RIS device.

In one embodiment, any one of the multiple identifiers is used to identify an RIS device.

In one embodiment, there at least exists one identifier in the multiple identifiers being used to identify a base station, and there at least exists another identifier in the multiple identifiers being used to identify an RIS device.

In one embodiment, the first identifier is for the first cell.

In one embodiment, the first cell is identified by the first identifier.

In one embodiment, one of the multiple identifiers is for the first cell.

In one embodiment, the first cell is an SCell of the first node, and the first identifier indicates an SpCell of the first node.

In one embodiment, the first node is a UE.

In one embodiment, the first node is a relay node.

In one embodiment, the first receiver 901 comprises at least one of the antenna 452, the receiver 454, the receiving processor 456, the multi-antenna receiving processor 458, the controller/processor 459, the memory 460, or the data source 467 in embodiment 4.

In one embodiment, the first transmitter 902 comprises at least one of the antenna 452, the transmitter 454, the transmitting processor 468, the multi-antenna transmitting processor 457, the controller/processor 459, the memory 460, or the data source 467 in embodiment 4.

### Embodiment 10

Embodiment 10 illustrates a structure block diagram of a processor in a second node according to one embodiment of the present application, as shown in FIG. 10. In FIG. 10, a processor 1000 in a second node comprises a second transmitter 1001 and a second receiver 1002.

In Embodiment 10, the second transmitter 1001 transmits a first reference signal; the first reference signal is a synchronization signal indicating a first identifier, or the first reference signal is spatially correlated with a synchronization signal indicating a first identifier; the second receiver 1002 receives a first radio signal on a first cell;

in embodiment 10, first PL is obtained by a transmitter of the first radio signal according to a measurement for the first reference signal; the first radio signal is transmitted adopting first power; the calculating first power depends on the first PL and a first parameter value; the first parameter value depends on the first identifier associated with the first reference signal.

In one embodiment, the first identifier associated with the first reference signal is a first candidate identifier, and the first parameter value is a first candidate parameter value; or, the first identifier associated with the first reference signal is a second candidate identifier, and the first parameter value is a second candidate parameter value.

In one embodiment, the first power is linearly correlated with a product of the first PL and the first parameter value.

In one embodiment, the first power is linearly correlated with a product of the first PL and a first coefficient, and the first power is linearly correlated with the first parameter value, and the first parameter value is used to determine expected power.

In one embodiment, comprising:
the second transmitter 1001 transmits a first signaling;
herein, the first signaling indicates the first identifier.

In one embodiment, comprising:
the second transmitter 1001 transmits a first broadcast signal;
herein, the first broadcast signal indicates multiple identifiers; the first identifier is one of the multiple identifiers.

In one embodiment, comprising:
the second transmitter 1001 transmits first physical-layer control information;
herein, the given identifier is any one of the multiple identifiers, and the first physical-layer control information occupies a first physical-layer channel, regardless of which of the multiple identifiers the given identifier is, a second identifier is used to generate at least one of a scrambling sequence of the first physical-layer channel or an RS sequence of a DMRS of the first physical-layer channel.

In one embodiment, the second node is a base station.

In one embodiment, the second node is a UE.

In one embodiment, the second node is a relay node.

In one embodiment, the second node is a maintenance device for a serving cell.

In one embodiment, the second node is a serving cell maintenance device of the first node.

In one embodiment, the second transmitter 1001 comprises at least one of the antenna 420, the transmitter 418, the transmitting processor 416, the multi-antenna transmitting processor 471, the controller/processor 475, or the memory 476 in embodiment 4.

In one embodiment, the second receiver 1002 comprises at least one of the antenna 420, the receiver 418, the receiving processor 470, the multi-antenna receiving processor 472, the controller/processor 475, or the memory 476 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID (Radio Frequency Identification) terminals, NB-IoT (Narrow Band Internet of Things) terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro cellular base stations, micro cellular base stations, small cellular base stations, home base stations, relay base stations, eNB (evolved Node B), gNB, TRP, GNSS (Global Navigation Satellite System), relay satellites, satellite base stations, airborne base stations, Road Side Units (RSUs), drones, testing equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for power control in wireless communications, comprising:
a first receiver, measuring a first reference signal to obtain a first PL (Pathloss); the first reference signal being a synchronization signal indicating a first identifier, or the first reference signal being spatially correlated with a synchronization signal indicating a first identifier; and
a first transmitter, calculating first power, adopting the first power to transmit a first radio signal on a first cell;
wherein the calculating first power depends on the first PL and a first parameter value; the first parameter value depends on the first identifier associated with the first reference signal.

2. The first node according to claim 1, wherein the first identifier associated with the first reference signal is a first candidate identifier, and the first parameter value is a first candidate parameter value; or, the first identifier associated with the first reference signal is a second candidate identifier, and the first parameter value is a second candidate parameter value.

3. The first node according to claim 1, wherein the first power is linearly correlated with a product of the first PL and the first parameter value.

4. The first node according to claim 1, wherein the first power is linearly correlated with a product of the first PL and a first coefficient, and the first power is linearly correlated with the first parameter value, and the first parameter value is used to determine expected power.

5. The first node according to claim 1, comprising:
the first receiver, receiving a first signaling;
wherein the first signaling indicates the first identifier.

6. The first node according to claim 1, comprising:
the first receiver, receiving a first broadcast signal;
wherein the first broadcast signal indicates multiple identifiers; the first identifier is one of the multiple identifiers.

7. The first node according to claim 1, comprising:
the first receiver, receiving first physical-layer control information;
wherein a given identifier is any one of the multiple identifiers, and the first physical-layer control information occupies a first physical-layer channel, regardless of which of the multiple identifiers the given identifier is, a second identifier is used to generate at least one of a scrambling sequence of the first physical-layer channel or an RS sequence of a DMRS (DeModulation Reference Signal) of the first physical-layer channel.

8. The first node according to claim 1, wherein the first identifier is used to identify a cell, or the first identifier is used to identify an RIS (Intelligent Reflecting Surface) device.

9. The first node according to claim 1, wherein the meaning of the first reference signal being spatially correlated with the synchronization signal indicating the first identifier comprises: the first reference signal and the synchronization signal correspond to a same TCI (Transmission Configuration Indicator) State.

10. The first node according to claim 2, wherein the first candidate identifier is configured to a base station and the second candidate identifier is configured to an RIS device, or the first candidate identifier is configured to an RIS device and the second candidate identifier is configured to a base station.

11. The first node according to claim 5, wherein an identifier associated with the first reference signal is one of K1 identifiers, K1 being a positive integer greater than 1, and the first signaling activates one of the K1 identifiers as the first identifier associated with the first reference signal.

12. The first node according to claim 6, wherein the first broadcast signal indicates a first value, and the first value and a sum of multiple offset values respectively generate the multiple identifiers, where the multiple offset values are fixed or predefined.

13. The first node according to claim 12, wherein the second identifier is a pre-defined identifier in the multiple identifiers.

14. A second node for power control in wireless communications, comprising:
a second transmitter, transmitting a first reference signal; the first reference signal being a synchronization signal indicating a first identifier, or the first reference signal being spatially correlated with a synchronization signal indicating a first identifier; and
a second receiver, receiving a first radio signal on a first cell;
wherein a first PL is obtained by a transmitter of the first radio signal according to a measurement for the first reference signal; the first radio signal is transmitted adopting first power; the calculating first power depends on the first PL and a first parameter value; the first parameter value depends on the first identifier associated with the first reference signal.

15. The second node according to claim 14, wherein the first identifier associated with the first reference signal is a first candidate identifier, and the first parameter value is a first candidate parameter value; or, the first identifier associated with the first reference signal is a second candidate identifier, and the first parameter value is a second candidate parameter value.

16. The second node according to claim 14, wherein the first power is linearly correlated with a product of the first PL and the first parameter value.

17. The second node according to claim 14, wherein the first power is linearly correlated with a product of the first PL and a first coefficient, and the first power is linearly correlated with the first parameter value, and the first parameter value is used to determine expected power.

18. The second node according to claim 14, comprising:
the second transmitter, transmitting a first signaling;
wherein the first signaling indicates the first identifier.

19. The second node according to claim 14, comprising:
the second transmitter, transmitting a first broadcast signal;
wherein the first broadcast signal indicates multiple identifiers; the first identifier is one of the multiple identifiers.

20. A method in a first node for power control in wireless communications, comprising:
measuring a first reference signal to obtain a first PL; the first reference signal being a synchronization signal indicating a first identifier, or the first reference signal being spatially correlated with a synchronization signal indicating a first identifier; and
calculating first power, adopting the first power to transmit a first radio signal on a first cell;
wherein the calculating first power depends on the first PL and a first parameter value; the first parameter value depends on the first identifier associated with the first reference signal.
